(19) United States
(12) Patent Application Publication
(10) Pub. No.: US 2015/0279535 A1
(43) Pub. Date: Oct. 1, 2015

(54) MAGNETIC LOCKING MECHANISMS, LINEAR MOVEMENTS GENERATORS, AND HOLDERS

(71) Applicant: Toshiba Global Commerce Solutions Holdings Corporation, Tokyo (JP)

(72) Inventors: Stacy Arrington, Morrisville, NC (US); Dean F. Herring, Youngsville, NC (US); Jeff D. Thomas, Raleigh, NC (US); David Brower, Wake Forest, NC (US); Robert A. Myers, Cary, NC (US); Seth T. Teeples, Raleigh, NC (US); Brad M. Johnson, Raleigh, NC (US); Phillip McLamb, Willow Springs, NC (US)

(73) Assignee: Toshiba Global Commerce Solutions Holdings Corporation, Tokyo (JP)

(21) Appl. No.: 14/228,654

(22) Filed: Mar. 28, 2014

(51) Int. Cl. H01F 7/02; G06F 1/16

(52) U.S. Cl. CPC H01F 7/0252; G06F 1/1632

(57) ABSTRACT

Magnetic locking mechanisms, linear movement generators, and holders are disclosed. According to an aspect, a magnetic locking mechanism includes a first component defining a first recess. The magnetic locking mechanism also includes a second component defining a second recess. Further, the magnetic locking mechanism includes a third component being attached to a first magnet and capable of being positioned in a first position such that the third component is partially within the first and second recesses for holding the first and second components together in at least one direction. Further, the third component is capable of being positioned in a second position such that the third component is outside of the first recess.

### CROSS REFERENCE TO RELATED APPLICATION

This application claims the benefit of U.S. Provisional Patent Application No. 61/897,858, filed Oct. 31, 2013 and titled MAGNETIC LOCKING MECHANISMS, LINEAR MOVEMENTS GENERATORS, AND HOLDERS, the content of which is hereby incorporated herein by reference in its entirety.

### TECHNICAL FIELD

The present invention relates to magnetic mechanisms. More particularly, the present invention relates to magnetic locking mechanisms, linear movements generators, and holders.

### BACKGROUND

Computing devices and other electronic devices are often attached to docking stations and other mechanisms. In the case of a docking station, an electronic device may be secured to the docking station by a mechanism for locking and holding the electronic device in place. In addition, a release mechanism may be used to unlock the electronic device from the docking station so that the electronic device can be removed. It is desired to provide improved and lower cost systems mechanisms for attaching electronic devices to docking stations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are magnetic locking mechanisms, linear movement generators, and holders. According to an aspect, a magnetic locking mechanism includes a first component defining a first recess. The magnetic locking mechanism also includes a second component defining a second recess. Further, the magnetic locking mechanism includes a third component being attached to a first magnet and capable of being positioned in a first position such that the third component is partially within the first and second recesses for holding the first and second components together in at least one direction. Further, the third component is capable of being positioned in a second position such that the third component is outside of the first recess.

According to another aspect, a magnetic linear movement generator includes a first magnet being rotatable along an axis. The movement generator also includes a second magnet having poles aligned along a direction substantially towards the axis. Further, the movement generator includes a mechanical constraint that holds the second magnet and constrains the second magnet to be moveable only in the direction.

According to another aspect, a magnetic linear movement generator includes a first magnet being rotatable along an axis in a z direction. The movement generator also includes a second magnet having poles aligned along an x direction that is substantially perpendicular to the z direction. Further, the movement generator includes a mechanical constraint that holds the second magnet and constrains the second magnet to be moveable only in a y direction that is substantially perpendicular to the x and z directions.

According to another aspect, a magnetic linear movement generator includes a first magnet being rotatable along a first axis. The movement generator also includes a second magnet being rotatable along a second axis that is substantially parallel with the first axis.

According to another aspect, a magnetic holder includes a first component having a substantially circular outer surface. The magnetic holder also includes a first magnet being attached to the first component. Further, the magnetic holder includes a second magnet being magnetically attracted to the first magnet. The magnetic holder also includes a second component having a substantially circular outer surface and being attached to the second magnet. Further, the magnetic holder also includes a mechanical constraint that holds the second magnet and the second component and constrains the second magnet and the second component to be moveable between first and second positions that align substantially in a direction towards the first magnet. The outer surfaces of the first and second components touch in the first position. The outer surfaces of the first and second components are spaced apart in the second position.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a perspective view of an example tablet computer 100 and docking station 102 configured with a magnetic locking mechanism in accordance with embodiments of the present invention;

FIG. 2 is a cross-sectional side view of a lower portion of the tablet computer and the docking station shown in FIG. 1;

FIG. 3 is a perspective view of the mechanism shown in FIG. 2 apart from the docking station;

FIG. 4 is a diagram showing another example magnetic locking mechanism in accordance with embodiments of the present invention;

FIG. 5 is a cross-sectional front view of the magnetic locking mechanism shown in FIG. 4 in accordance with embodiments of the present invention;

FIG. 6 is a diagram showing another example magnetic locking mechanism in accordance with embodiments of the present invention;

FIG. 7 is a side cross-sectional view of the locking mechanism shown in FIG. 6;

FIG. 8 is a diagram showing an example magnetic linear movement generator in accordance with embodiments of the present invention;

FIGS. 9A-9D are diagrams showing another magnetic linear movement generator in accordance with embodiments of the present invention;

FIGS. 10A-10D are diagrams showing a magnetic gear mechanism in accordance with embodiments of the present invention; and

FIGS. 11A and 11B are perspective views of a magnetic holder in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

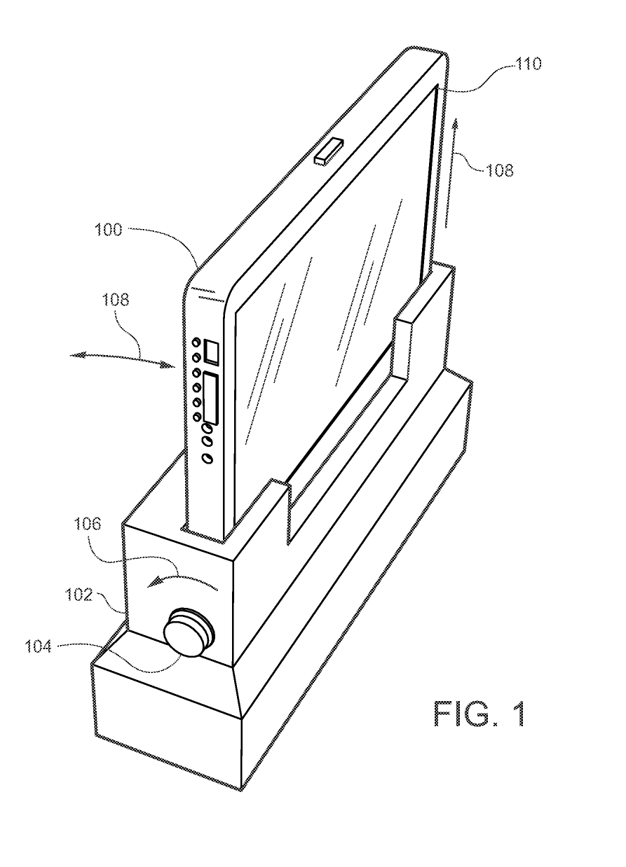

FIG. 1 illustrates a perspective view of an example tablet computer 100 and docking station 102 configured with a magnetic locking mechanism in accordance with embodiments of the present invention. It is noted that although this example involves the attachment of a computing device to a docking station, the same or similar magnetic locking mechanism may be used to attach any type of electronic device to a docking station or any other type of component. Referring to FIG. 1, the tablet computer 100 can be removed from the docking station 102 when the magnetic locking mechanism is in an unlocked state. In a locked state, the docking station 102 and the tablet computer 100 may be held together by the magnetic locking mechanism. When the tablet computer 100 is positioned as shown in FIG. 1, the docking station 102 and the tablet computer 100 may enter the locked state from an unlocked state by turn of a knob 104 in a direction indicated by direction arrow 106. Conversely, the knob 104 may be turned in a direction that opposed direction arrow 106 to return to the unlocked state in which the tablet computer 100 may be removed. When in the unlocked state, the tablet computer 100 may be removed from the docking station 102 by lifting the tablet computer 100 in a direction indicated by direction arrow 108.

It is also noted that the docking station 102 may include a suitable mechanism for rotation of the tablet computer 100 back-and-forth along a direction indicated by double arrow 108. In this way, a user may tilt the tablet computer 100 such that a display 110 can be better viewed.

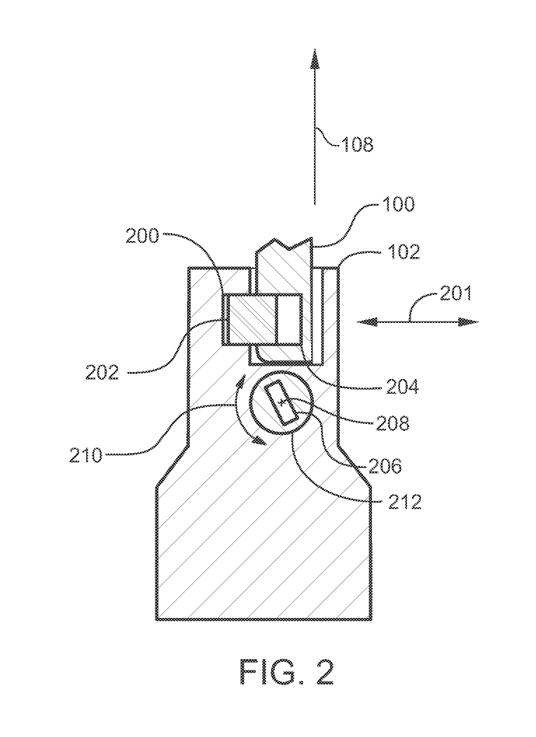

FIG. 2 illustrates a cross-sectional side view of a lower portion of the tablet computer 100 and the docking station 102 shown in FIG. 1. Only a lower portion of the tablet computer 100 is shown in this view for ease of illustration. Referring to FIG. 2, the docking station 102 has a recess 200 formed therein for receipt of at least a portion of a magnet 202 for locking the tablet computer 100 in position with respect to the docking station 102. In addition, the tablet computer 100 has a recess 204 formed therein for receipt of the entirety or a portion of the magnet 202. The magnet 202 is moveable (as indicated by double arrow 201) between a position entirely within the recess 204 and another position such that the magnet 202 is partially within the recess 200 and partially within the recess 204. When the magnet 202 is partially within both recesses 200 and 204, the tablet computer 100 is in the locked state because the magnet 202 physically engages both the tablet computer 100 and the docking station 102 for preventing movement of the tablet computer 100 in the direction 108. When the magnet 202 is entirely within the recess 204, the tablet computer 100 is in the unlocked state because the magnet 202 does not physically engage the docking station 102 to prevent movement of the tablet computer 100 in the direction 108.

It is noted that in an alternative example, the magnet 202 may be attached to a component that is moveable along with the magnet 202. In the locked state, the magnet 106 and/or a component attached thereto may have a portion in the recess 200 and another portion in the recess 204. In the unlocked state, the magnet 106 and/or a component attached thereto may be positioned entirely outside of the recess 200 such that the component 104 is moveable in at least the direction indicated by direction arrow 108.

The magnet 202 may be influenced by a magnetic field of another magnet to move between positions of the unlocked state and the locked state. In the example of FIG. 2, a magnet 206 is positioned in proximity to the magnet 202 for influencing movement of the magnet 202 when the tablet computer 100 is in the position as shown. Particularly, the magnet 206 is sufficiently close to the magnet 202 such that the magnetic field of the magnet 206 can control the magnet 202 to move along the direction 201 when the magnet 206 is rotated about its axis 208 in either directions of double arrow 210. When the magnet 206 is rotated counterclockwise about the axis 208, the magnet 202 can move leftward along direction 201. Conversely, when the magnet 206 is rotated clockwise about the axis 208, the magnet 202 can move rightward along the direction 201.

The docking station 102 includes a rotatable mechanism 212 configured to hold the magnet 206. The mechanism 212 may be attached to the knob 104 shown in FIG. 1. The mechanism 212 may be cylindrical in shape and be configured to rotate about the axis 208 when the knob 104 is turned. The magnet 206 may also turn when the mechanism 212 is turned by the knob 104 for effecting movement of the magnet 202 to either the locked state or the unlocked state. Thus, a user may change the magnetic locking mechanism between the locked and unlocked states by rotation of the knob 104.

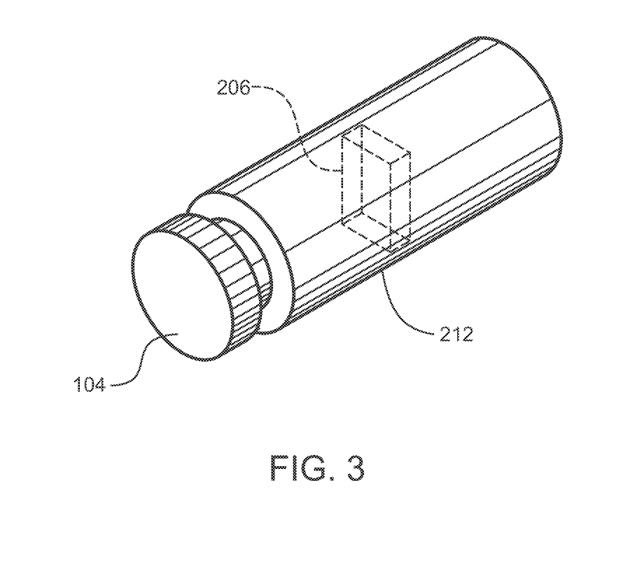

FIG. 3 illustrates a perspective view of the mechanism 212 apart from the docking station 102. This figures shows the cylindrical shape of the mechanism 212. Although, it is noted that any suitable shape and mechanism may be utilized.

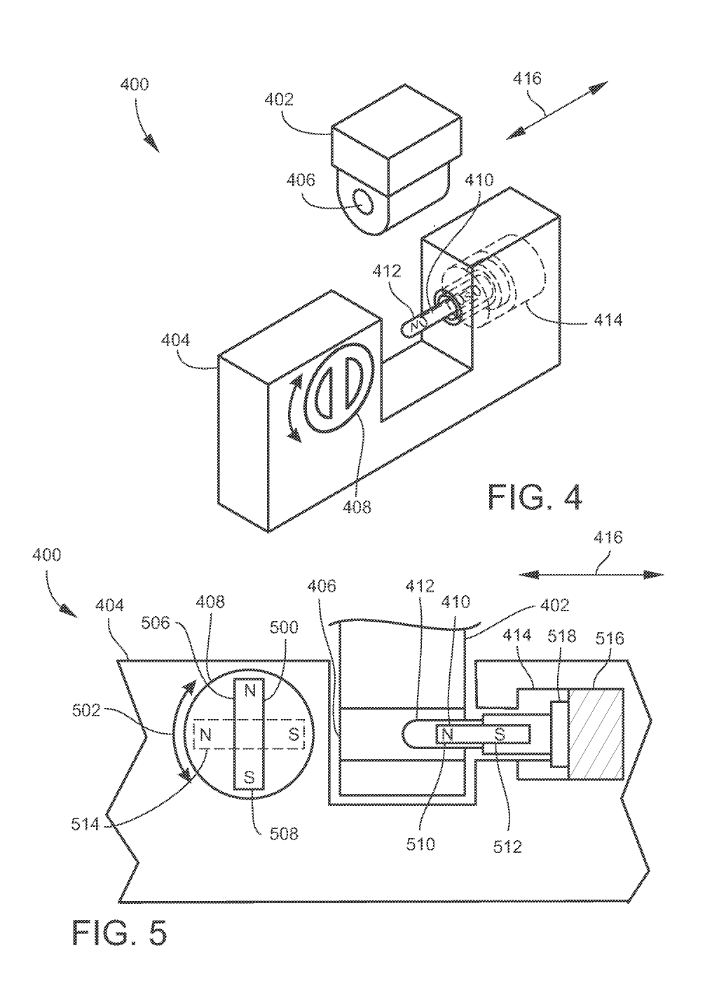

FIG. 4 illustrates a diagram showing another example magnetic locking mechanism 400 in accordance with embodiments of the present invention. This example mechanism 400 may be used for attaching a computing device (not shown) to a docking station (not shown). For example, the mechanism 400 may include a locking receptacle 402 attached to the computing device. The mechanism 400 may include a base component 404 attached to the docking station. It is noted that the magnetic locking mechanism may be used to attach any type of electronic device to a docking station or any other type of component. The locking receptacle 400 defines an aperture 406.

The base component 404 may include a magnetic dial 408 having a locked setting and an unlocked setting. The magnetic dial 408 may be rotated by a user to one position for locking the locking receptacle 402 to the base component 404. Conversely, the magnetic dial 408 may be rotated by the user to another position for unlocking and thereby releasing the locking receptacle 402 from the base component 404. Particularly, the magnetic dial 408 may be attached to a magnet positioned for influencing another magnet 410 positioned within a plunger 412. The plunger 412 may be positioned within a recess 414 of the base component 404 and be configured to move within the recess 414 along directions indicated by double arrow 416. An end of the plunger 412 may fit into the aperture 406 when in the locked position. In the unlocked position, the locking receptacle 402 along with an electronic device attached thereto may be lifted upward to be disconnected from the base component 404. The magnet 410 has north and south poles that are aligned in a direction of movement of the plunger 412 when influenced by the magnet attached to the magnetic dial 408.

FIG. 5 illustrates a cross-sectional front view of the magnetic locking mechanism 400 shown in FIG. 4 in accordance with embodiments of the present invention. Referring to FIG. 5, a magnet 500 is attached to the magnetic dial 408 for rotation in directions indicated by double arrow 502. The magnet 500 has a north pole end 506 and a south pole end 508. The magnet 500 is positioned near the magnet 410 such that the magnetic field of the magnet 500 influences the movement of the magnet 410. A north pole end 510 of the magnet 410 is directed toward the magnet 500, whereas a south pole end 512 of the magnet 410 is directed away from the magnet 500. In a locked setting, the south pole end 508 of the magnet 500 faces the magnet 410 such that the magnet 410 is influenced to move towards the magnet 500. In this way, the magnet 410 is attracted towards the magnet 500 because of the orientation of the north pole end of the magnet 410. The position of the magnet 500 in the locked setting is indicated by broken lines 514. Further, in this setting, the plunger 412 moves and is inserted into the aperture 406 due to the magnetic attraction. In this way, the locking receptacle 402 is held by the base component 404.

In an unlocked setting, the magnetic dial 500 is rotated such that the north pole end 506 faces the north pole end 510 of the magnet 410 to provide a repelling force on the magnet 410. In this way, the plunger 412 moves away from and out of the aperture 406 such that the locking receptacle 402 can be removed.

The locking mechanism 400 includes a plug 516 for interface with an end of the plunger 412. Further, the plunger 412 includes a shoulder 518 for stopping the plunger 412 from exiting the recess 414.

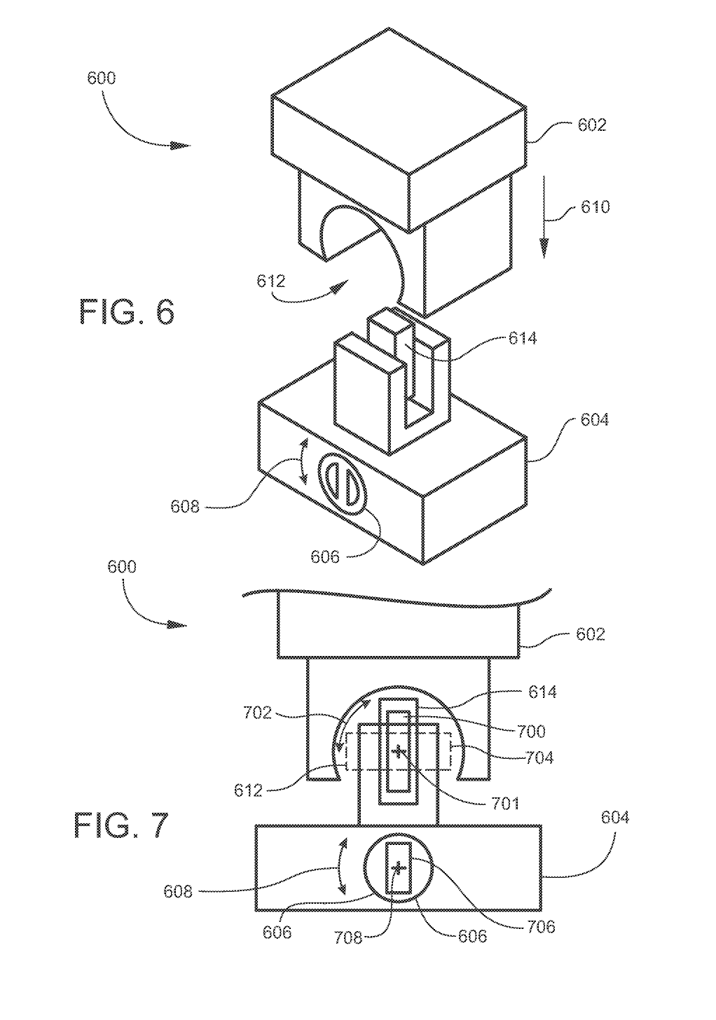

FIG. 6 illustrates a diagram showing another example magnetic locking mechanism 600 in accordance with embodiments of the present invention. This example mechanism 600 may be used for attaching a computing device (not shown) to a docking station (not shown). For example, the mechanism 600 may include a locking receptacle 602 attached to the computing device. The mechanism 600 may include a base component 604 attached to the docking station. It is noted that the magnetic locking mechanism may be used to attach any type of electronic device to a docking station or any other type of component. Referring to FIG. 6, the locking receptacle 602 and the base component 604 that can be attached together by use of magnets as will be described in further detail. Particularly, a magnetic dial 606 has a locked setting and an unlocked setting. The magnetic dial 606 can be rotated by a user to one position for locking the locking receptacle 602 to the base component 604. Conversely, the magnetic dial 606 may be rotated by the user to another position for unlocking and thereby releasing the locking receptacle 602 from the base component 604. The magnetic dial may rotate in the directions indicated by double arrow 608.

To set to lock, the locking receptacle 602 may be move downward in the direction 610 such that an opening 612 defined in the receptacle 602 is substantially surrounds a pivotal component 614. The pivotal component 614 is configured to rotate about an axis and within the opening 612 when surrounded by the opening 612. The pivotal component 614 includes a magnet that can be influenced by a magnet that is rotatable by the magnetic dial 606. As the magnetic dial 606 is turned, the magnet in the magnetic dial 606 causes the magnet in the pivotal component 614 to move to thereby rotate the pivotal component 614. When the rotatable component 614 is oriented vertically as shown, the locking receptacle 602 is unlocked such that is may be moved upward and away from the base component 604. In contrast, when the rotatable component is oriented horizontally, the locking receptacle 602 is locked such that the locking receptacle 602 is secured to the base component 604. The locking receptacle 602 becomes secured when the pivotal component 614 is positioned horizontally because the pivotal component 614 is situated in the opening 612 such that it cannot be removed, as will be discussed in further detail.

FIG. 7 illustrates a side cross-sectional view of the locking mechanism 600 shown in FIG. 6. Referring to FIG. 7, the mechanism 600 is shown, in this example, with the locking receptacle 602 being positioned for either lock or unlocked of the locking receptacle 602 with the base component 604. The pivotal component 614 includes a magnet 700 that can be magnetically-influenced for movement to thereby rotate the pivotal component 614 about an axis 701. The pivotal component 614 may be positioned vertically as shown such that the locking receptacle 602 may be removed from the base component 604. Conversely, the pivotal component 614 may rotate along directions indicated by double arrow 702 such that the pivotal component 614 is positioned horizontally as depicted by broken lines 704. In the horizontal position, the pivotal component 614 is positioned such that it cannot be removed from the opening 612 to thereby hold the locking receptacle 602 in place as shown in FIG. 7.

The magnetic dial 606 may be attached to a magnet 706 that is positioned to influence movement of the magnet 700. For example, the magnetic dial 606 may be turned to rotate the magnet 706 about an axis 708. In this way, the rotation of the magnet 706 can cause the magnet 700 to rotate for moving the pivotal component 700 into locked and unlocked positions.

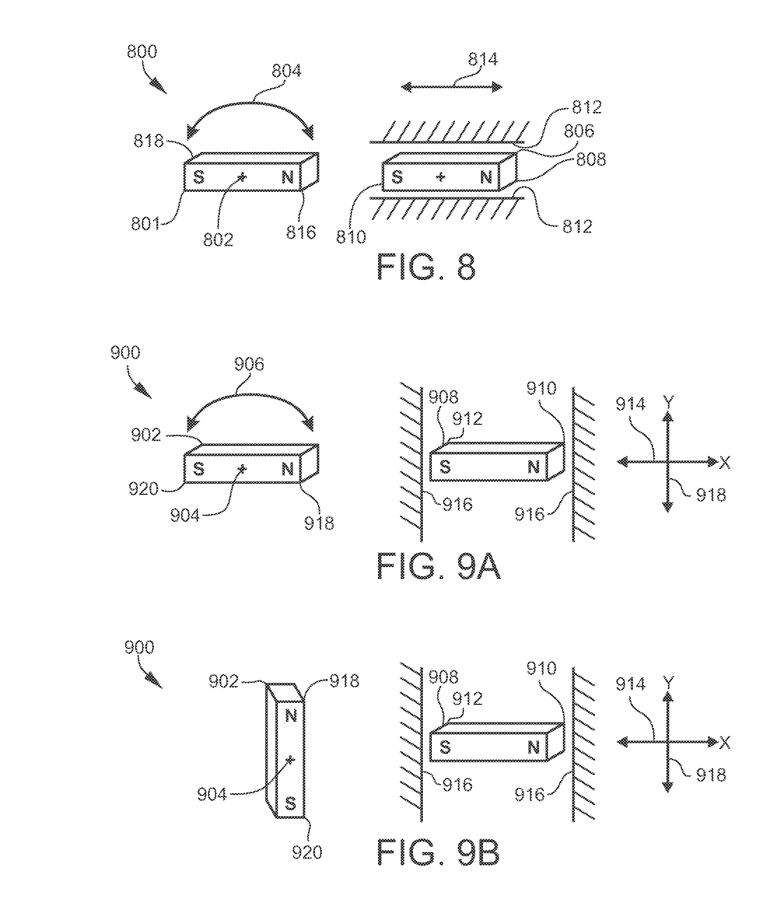

FIG. 8 illustrates a diagram showing a magnetic linear movement generator 800 in accordance with embodiments of the present invention. Referring to FIG. 8, the movement generator 800 may include a magnet 801 being rotatable along an axis 802 in directions indicated by double arrow 804. The movement generator 800 may also include another magnet 806 having north and south pole ends 808 and 810 aligned along a direction substantially towards the axis 802. Further, the movement generator 800 includes a mechanical constraint 812 that can hold the magnet 806 and that constrains the magnet 806 to be moveable only in the directions indicated by double arrow 814.

The magnet 801 is positioned sufficiently close to the magnet 806 such that the magnetic field of the magnet 801 influences movement of the magnet 806. More particularly, by rotation of the magnet 801 about its axis 802, the magnet 806 can be controlled to move back-and-forth along the directions of double arrow 814. The magnet 801 is configured to rotate about the axis 802 for movement of the magnet 806 along the direction 814. The magnet 801 is controllable to rotate about the axis. The magnet 801 may be pivotally connected at the axis 802 to a suitable mechanism for pivot about the axis 802. Further, a mechanism may controllably rotate the magnet 801 about the axis 802 for effecting movement of the magnet 806.

As shown in FIG. 8, the magnet 801 is positioned laterally such that a north pole end 816 is directed towards the south pole end 810 of the magnet 812. In this way, the magnet 801 can influence the magnet 806 to move leftward towards the magnet 801. Movement of the magnet 806 in this direction may be suitably controlled by a stop or other mechanical feature positioned to prevent further movement of the magnet 806.

To move the magnet 806 to the right away from the magnet 801, the magnet 801 may be rotated such that a south end 818 of the magnet 801 is directed towards the south end 810 of the magnet 806. In this way, the magnet 801 can repel the magnet 806. Movement of the magnet 806 in this direction may be suitably controlled by a stop or other mechanical feature positioned to prevent further movement of the magnet 806.

It is also noted that the magnet 806 may be suitable connected to another component or mechanism. For example, the magnet 806 may be suitably connected to a component for movement of the component in the directions 814. In an example, the magnet 806 may be suitably connected to a pump mechanism.

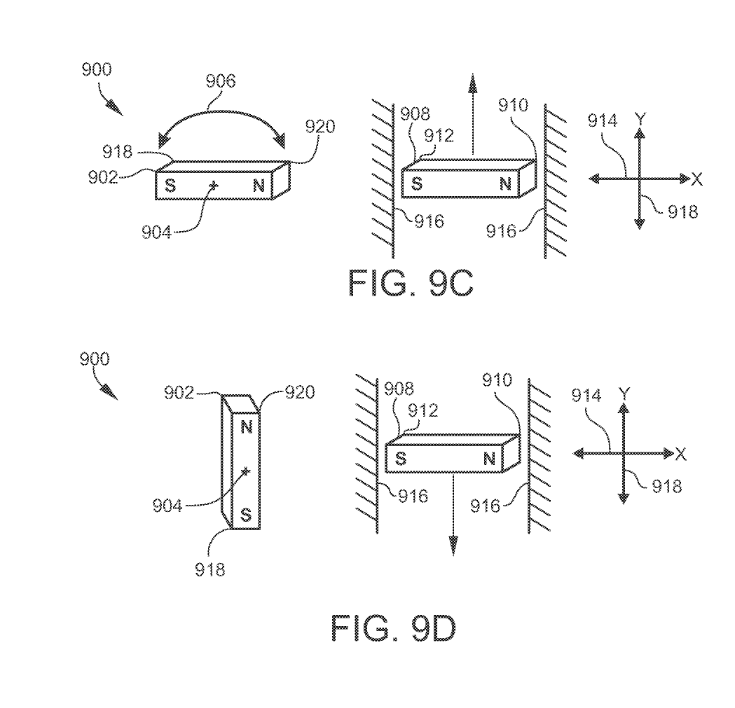

FIGS. 9A-9D illustrate diagrams showing another magnetic linear movement generator 900 in accordance with embodiments of the present invention. Referring to FIG. 9A-9D, the movement generator 900 may include a magnet 902 that is configured to rotate along an axis 904. The magnet 902 may be pivotally connected to a suitable mechanism for rotation in directions indicated by double arrow 906. Further, the magnet 902 may be suitably controlled by a mechanism for rotation in the directions 906. The movement generator 900 may include another magnet 908 that is positioned sufficiently close to the magnet 902 such that the magnet 908 is influenced by the magnetic field generated by the magnet 902.

The magnet 908 has north and south pole ends 910 and 912, respectively, which are aligned along an x direction 914 that is substantially perpendicular to the axis 904 of rotation of the magnet 801. Further, the movement generator 900 includes a mechanical constraint 916 that holds the magnet 908 and constrains the magnet 908 to be moveable only in a y direction 918 that is substantially perpendicular to the x direction 914 and the axis 904.

The magnet 902 is configured to rotate about the axis 904 to effect movement of the magnet 908 along the y direction 918. The magnet 902 is controllable to rotate about the axis 904 to in turn effect movement of the magnet 908 along the y direction 918. Referring particularly now to FIG. 9A, the magnet 904 is positioned laterally such that a north pole end 918 is nearest to the south pole end 912 of the magnet 908 such that the magnet 908 is held in place and resists movement in the y direction 918. In this way, the magnet 908 can be controllably locked in position.

Referring to FIG. 9B, the magnet 904 is positioned vertically such that the north pole end 918 is positioned upward and thereby attracts movement of the magnet 908. The magnet 908 is influenced to move upward. This is due to the placement of south pole end 912 of the magnet 908 nearest the magnet 902.

Referring to FIG. 9C, the magnet 904 is positioned horizontally such that a south pole end 920 of the magnet 904 is nearest to the south pole end 912 of the magnet 908. In this way, the magnet 908 may more freely move along the y direction 918.

Referring to FIG. 9D, the magnet 904 is positioned vertically such that the north pole end 918 is positioned downward and thereby attracts movement of the magnet 908. The magnet 908 is influenced to move downward.

It is noted that the magnet 908 may be suitable connected to another component or mechanism. For example, the magnet 908 may be suitably connected to a component for movement of the component in the y direction 918. In an example, the magnet 908 may be suitably connected to a pump mechanism. Further, it is noted that the extent of movement of the magnet 908 can be suitably controlled by placement of stops or any other mechanism for controlling movement.

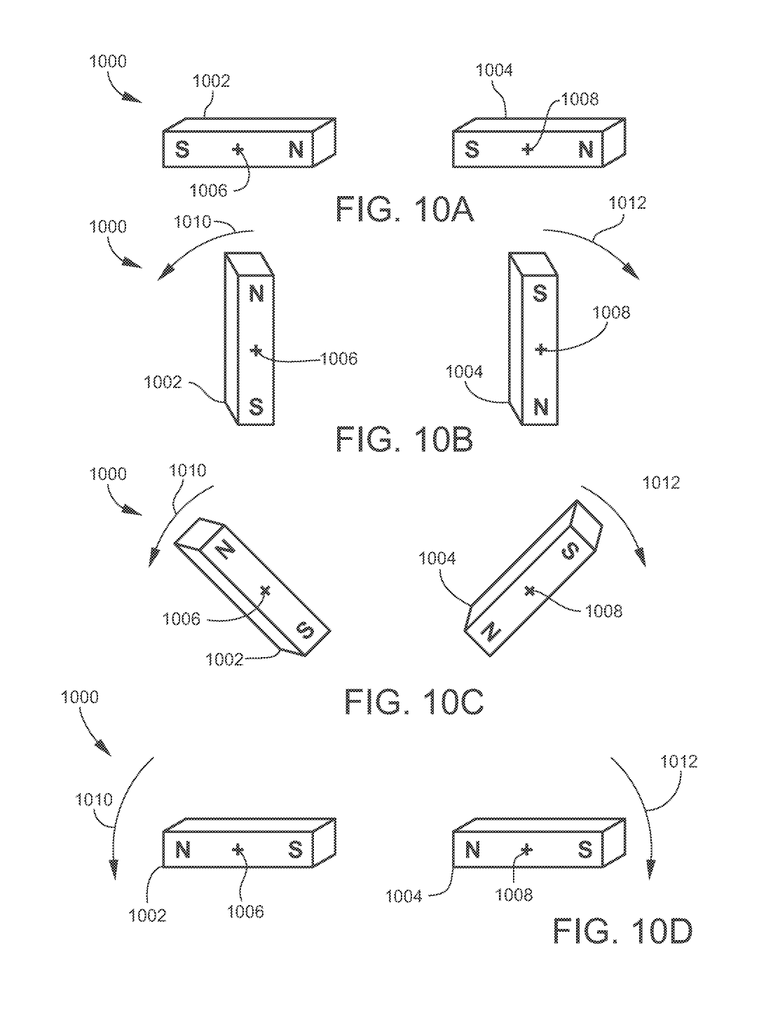

FIGS. 10A-10D illustrate diagrams showing a magnetic gear mechanism 1000 in accordance with embodiments of the present invention. Referring to FIGS. 10A-10D, the gear mechanism 1000 includes magnets 1002 and 1004 configured to rotate about axes 1006 and 1008, respectively. Rotation of one of the magnets 1002 and 1004 about its axis can cause the other magnet to rotate in an opposing direction along its axis as depicted in FIGS. 10B-10D. Referring to FIG. 10A as an example, when the magnets 1002 and 1004 are each held laterally with their poles aligned as shown, the magnets are held steady and can become locked when the north pole of one is positioned nearest the south pole of the other. To effect movement of the other magnet for example, one of the magnets may be rotated as shown by the arrow. For example, FIGS. 10B-10D show rotation along arrows 1010 and 1012. One magnet can controllably rotate the rotation of the other magnet about its respective axis.

In an example application of the mechanism 100 shown in FIGS. 10A-10D, the magnets 1002 may be suitably attached to other components for rotation and locking in place of the other component. Such movement may be controlled by movement of the other magnet. This mechanism may be applied, for example, to implement a toothless gear transmission.

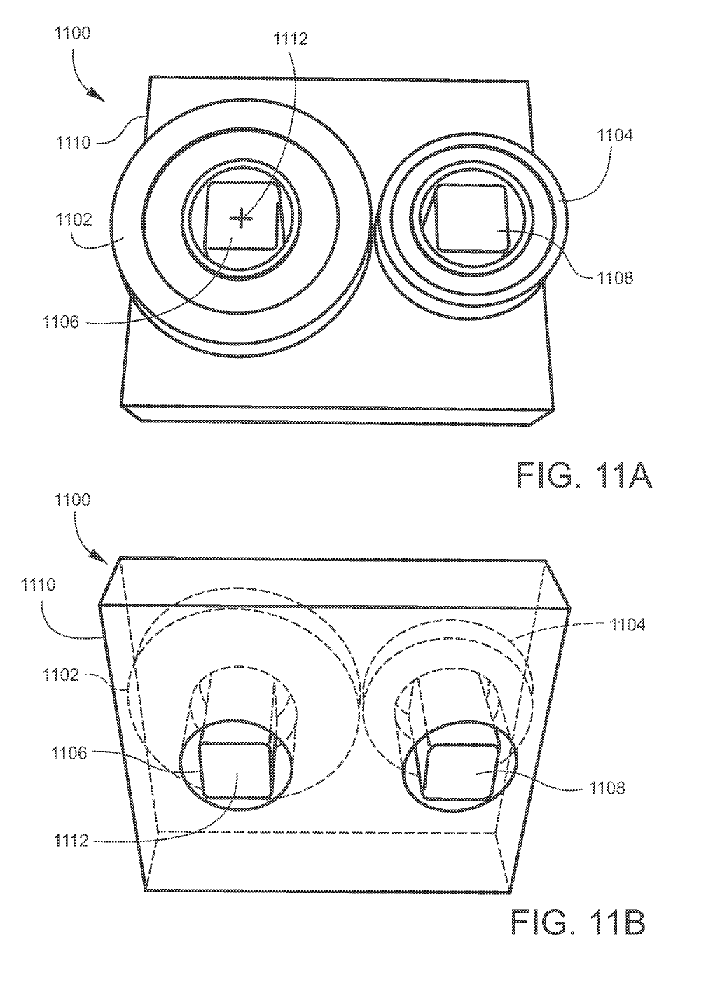

FIGS. 11A and 1 lB are perspective views of a magnetic holder 1100 in accordance with embodiments of the present invention. Referring to FIGS. 11A and 11B, the magnetic holder 1100 includes components 1102 and 1104 that each have substantially circular outer surfaces. The components 1102 and 1104 are each attached to respective magnets 1106 and 1108, respectively. The magnets 1106 and 1108 are sufficiently close such that they are magnetically attracted to each other. The component 1102 is constrained by a base unit 1110 such that it can only rotate about an axis 1112, which is at about the center of the magnet 1106 in this example. Thus, the outer surface of the component 1102 can substantially rotate about the magnet 1106.

The base unit 1110 may function as a mechanical constraint that holds the magnet 1108 and the component 1104 and constrains the magnet 1108 and the second component 1104 to be moveable between first and second positions that align substantially in a direction towards the magnet 1106. The outer surfaces of the components 1102 and 1104 touch in one position as shown in FIG. 11B. In the other position, the outer surfaces of the components 1102 and 1104 are spaced apart. In an example, several sheets of paper may be placed in the space between component 1102 and 1104. In an example use case, the magnetic holder 1100 may be used for guiding and holding paper in a printer.

It is noted that the magnets disclosed herein may be any type of suitable magnets such as, but not limited to, rare earth magnets.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A magnetic locking mechanism comprising:
a first component defining a first recess;
a second component defining a second recess;
a third component being attached to a first magnet and capable of being positioned in a first position such that the third component is partially within the first and second recesses for holding the first and second components together in at least one direction, and capable of being positioned in a second position such that the third component is outside of the first recess; and
a second magnet capable of generating a magnet field that can change for moving the third component between the first and second positions.

2. The magnetic locking mechanism of claim 1, wherein the first component is part of a docking station, and wherein the second component is part of an electronic device.

3. The magnetic locking mechanism of claim 1, wherein the first magnet includes first and second poles, and wherein the first and second poles are positioned in the first and second recesses, respectively, when the first magnet is positioned in the first position.

4. The magnetic locking mechanism of claim 1, wherein the third component can engage surfaces of the first and second recesses for moving between the first and second positions.

5. The magnetic locking mechanism of claim 4, wherein at least a portion of one of the surfaces of the first and second recesses is rough for resisting movement of the third component between the first and second positions.

6. The magnetic locking mechanism of claim 4, wherein at least a portion of the surface of the third component is rough for resisting movement of the third component between the first and second positions.

7. The magnetic locking mechanism of claim 1, further comprising a fourth component attached to the second magnet and being configured to move the second magnet such that the magnetic field generated by the second magnet causes movement of the first magnet for moving the third component between the first and second positions.

8. The magnetic locking mechanism of claim 7, wherein the fourth component is rotatable.

9. The magnetic locking mechanism of claim 8, wherein the fourth component is manually rotatable.

10. The magnetic locking mechanism of claim 1, wherein the magnets are rare earth magnets.

11. The magnetic locking mechanism of claim 1, wherein the first and second recesses constrain the third component to only moving between the first and second components.

12. The magnetic locking mechanism of claim 1, wherein the first and second components configured to fit together such that the first and second recesses meet one another such that the third component is moveable between the first and second positions.

13. The magnetic locking mechanism of claim 12, wherein when the first and second components are fitted together and the third component is in the first position, the first and second components are substantially held together.

14. The magnetic locking mechanism of claim 13, wherein when the first and second components are fitted together and the third component is in the second position, the first and second components is moveable in the at least one direction.

15. A magnetic linear movement generator comprising:
a first magnet being rotatable along an axis;
a second magnet having poles aligned along a direction substantially towards the axis; and
a mechanical constraint that holds the second magnet and constrains the second magnet to be moveable only in the direction.

16. The magnetic linear movement generator of claim 1, wherein the first magnet is configured to rotate about the axis for movement of the second magnet along the direction.

17. The magnetic linear movement generator of claim 1, wherein the first magnet is controllable to rotate about the axis.

18. A magnetic linear movement generator comprising:
a first magnet being rotatable along an axis in a z direction;
a second magnet having poles aligned along an x direction that is substantially perpendicular to the z direction; and
a mechanical constraint that holds the second magnet and constrains the second magnet to be moveable only in a y direction that is substantially perpendicular to the x and z directions.

19. The magnetic linear movement generator of claim 18, wherein the first magnet is configured to rotate about the axis for movement of the second magnet along the y direction.

20. The magnetic linear movement generator of claim 18, wherein the first magnet is controllable to rotate about the axis.

21. A magnetic linear movement generator comprising:
a first magnet being rotatable along a first axis; and
a second magnet being rotatable along a second axis that is substantially parallel with the first axis.

22. The magnetic linear movement generator of claim 21, wherein the first magnet is configured to rotate about the first axis for movement of the second magnet along the second direction.

23. A magnetic holder comprising:
a first component having a substantially circular outer surface;
a first magnet being attached to the first component;
a second magnet being magnetically attracted to the first magnet;
a second component having a substantially circular outer surface and being attached to the second magnet; and
a mechanical constraint that holds the second magnet and the second component and constrains the second magnet and the second component to be moveable between first and second positions that align substantially in a direction towards the first magnet, wherein the outer surfaces of the first and second components touch in the first position, and wherein the outer surfaces of the first and second components are spaced apart in the second position.
